(19) United States
(12) Patent Application Publication
(10) Pub. No.: US 2012/0299829 A1
(43) Pub. Date: Nov. 29, 2012

(54) Computer Input Device

(76) Inventors: Cary Evans, Encinitas, CA (US); Raymond Kim, San Diego, CA (US)

(21) Appl. No.: 13/477,028

(22) Filed: May 21, 2012

Related U.S. Application Data
(60) Provisional application No. 61/489,244, filed on May 23, 2011.

(51) Int. Cl. G06F 3/033

(52) U.S. Cl. 345/161

(57) ABSTRACT

A computer input device configured to accept a user's hand palm down is disclosed. A handle is affixed on top of a stick, which in turn is secured to a base, where the user moves the handle with the user's palm to move the stick relative to the base in a plurality of axes. The handle includes a plurality of buttons that can be activated by the user's digits. The computer input device has a low overall profile with a low center of gravity and a relatively small footprint and is preferably used in conjunction either with another computer input device of a similar configuration or a computer mouse-style input device.

### CROSS REFERENCE TO RELATED APPLICATIONS

This application claims the benefit of U.S. Provisional App. No. 61/489,244 filed on May 23, 2011, the entirety of which is hereby incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of computer hardware, and more specifically toward a computer input device configured to accept a user's hand palm down. A handle is affixed on top of a stick, which in turn is secured to a base, where the user moves the handle with the user's palm to move the stick relative to the base in a plurality of axes. The handle includes a plurality of buttons that can be activated by the user's digits. The computer input device has a low overall profile with a low center of gravity and a relatively small footprint and is preferably used in conjunction either with another computer input device of a similar configuration or a computer mouse-style input device.

In order to navigate a real or virtual three-dimensional (3D) environment, such as in a video game, the prior art teaches using a computer mouse in combination with a keyboard. The mouse controls the view and direction. By moving the mouse, the direction of the current view is changed up, down, left or right, similar to moving your head up, down, left, or right. At the same time, the keyboard is used to control movement within the environment, wherein pressing particular keys on the keyboard causes forward, backward, and sideways movement. A typical configuration will use the W, A, S, and D keys of a keyboard to move forward, laterally to the left, backwards, and laterally to the right respectively.

On one hand, direction of view is being controlled by large/gross motor skills of controlling a mouse while the other hand is engaged in a fine motor skill (typing) to control movement within an environment. Cognitively, this is difficult to learn and master. Additionally, on the hand that is using the keyboard, typically there are three (3) fingers being used to operate movement via keys (such as the W, A, S, and D keys). By having three fingers dedicated to movement, that leaves only two other fingers available to press keys to enable other types of movement or interactions such as crouching, running, jumping, leaning around corners, picking up items, switching weapons, and other types of interactions within a 3D environment such as a video game.

It is possible to configure a computer such that a mouse can be used on one hand and a joystick can be used on the other. In this fashion, the joystick is used to control movement in an environment. A mouse is used with their palm facing down on one hand and the other hand is grabbing a vertical joystick. With the palms of the hands positioned in two different orientations, it is cognitively more difficult to learn how to use the two devices in concert. This is caused not only by the difference in direction that the palms of the hand are facing, but also by the fact that existing joystick grips are elevated well above the surface that supports the joystick. In other words, the hand controlling the mouse is positioned on a desk or flat surface, while the other hand controlling the joystick is elevated well above desk or flat surface leaving the hands in different elevations.

Thus there has existed a long-felt need for a computer input device that enables users to interact with a 3D environment using both hands in similar orientations at similar elevations.

### SUMMARY OF THE INVENTION

The current invention provides just such a solution by having a computer input device configured to accept a user's hand palm down. A handle is affixed on top of a stick, which in turn is secured to a base, where the user moves the handle with the user's palm to move the stick relative to the base in a plurality of axes. The handle includes a plurality of buttons that can be activated by the user's digits. The computer input device has a low overall profile with a low center of gravity and a relatively small footprint, and is preferably used in conjunction either with another computer input device of a similar configuration or a computer mouse-style input device.

The computer input device disclosed herein is a joystick like controller whose shape affords the position of the operator's palm to be facing down. This enables the operator to navigate a real or virtual 3D environment using a mouse in one hand and the joystick controller in the other. By having both hands with the palms facing down, the use of both hands together to move through space is intuitive and can be mastered in a significantly faster period of time than through the use of prior art devices. Additionally, by allowing the operator to use gross motor skills to operate the joystick, all five fingers are available to press buttons on the computer input device enabling things like crouching, jumping, switching weapons, picking items up, and other interactivity in a virtual 3D environment.

It is an object of the invention to provide a computer input device that enables a user to interact with a computer.

It is another object of the invention to provide a computer input device where the user grasps a portion of the computer input device with the user's palm facing downward.

It is a further object of this invention to provide a computer input device with a low profile.

It is an additional object of the invention to provide a computer input device with a low center of gravity.

It is an added object of the invention to provide a computer input device with a small overall footprint.

It is another object of the invention to provide a computer input device with buttons accessible by each of a user's fingers.

In a particular embodiment, the current invention is a computer input device comprising a base, a stick, and a handle, two stick sensors, two motors, a light emitting diode, a central processing unit, and a data port, where the stick operably connects the handle to the base, where the handle is perpendicular to the stick, where the handle comprises a plurality of handle buttons and a plurality of pad buttons, wherein a user may depress one or more of the handle buttons with the user's fingers, wherein a user may depress one or more of the pad buttons with the user's thumb, where the base comprises a plurality of buttons, wherein a user may depress one or more of the buttons of the base with the user's fingers, where the central processing unit processes input provided by the handle buttons, the pad buttons, the buttons of the base, and the stick sensors, where the central processing unit provides output through the data port, where the central processing unit activates the motors and light emitting diode, where the two stick sensors measure the angular displacement of the stick, where the two motors are in mechanical connection with the stick such that the motors provide force feedback to a user when activated by the central processing unit, whereby a user may interact with a computer connected to the computer input device via the data port by displacing the stick or depressing one or more of the pad buttons of the handle, the handle buttons of the handle, or the buttons of the base.

In another embodiment, the current invention is a method of controlling a computer comprising the steps of: obtaining a computer input device comprising a base, a stick, a handle, and a data port, where the stick operably connects the handle to the base, where the handle is perpendicular to the stick, where the handle comprises a plurality of handle buttons and a plurality of pad buttons, wherein a user may depress one or more of the handle buttons with the user's fingers, wherein a user may depress one or more of the pad buttons with the user's thumb, connecting a personal computer to the computer input device via the data port, and providing directional input to the computer by displacing the stick.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a front perspective view of a computer input device according to selected embodiments of the current disclosure.

FIG. 2 is a back perspective view of a computer input device according to selected embodiments of the current disclosure.

FIG. 3 is a front perspective view of a hand grasping a computer input device according to selected embodiments of the current disclosure.

FIG. 4 is a front perspective view of a user engaging buttons on the base of a computer input device according to selected embodiments of the current disclosure.

FIG. 5 is a schematic view of electrical components of a computer input device according to selected embodiments of the current disclosure.

FIG. 6 is a diagram of the main electrical components of a computer input device according to selected embodiments of the current disclosure.

FIG. 7 is a diagram of the connections between a computer input device and a game console connector according to selected embodiments of the current disclosure.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

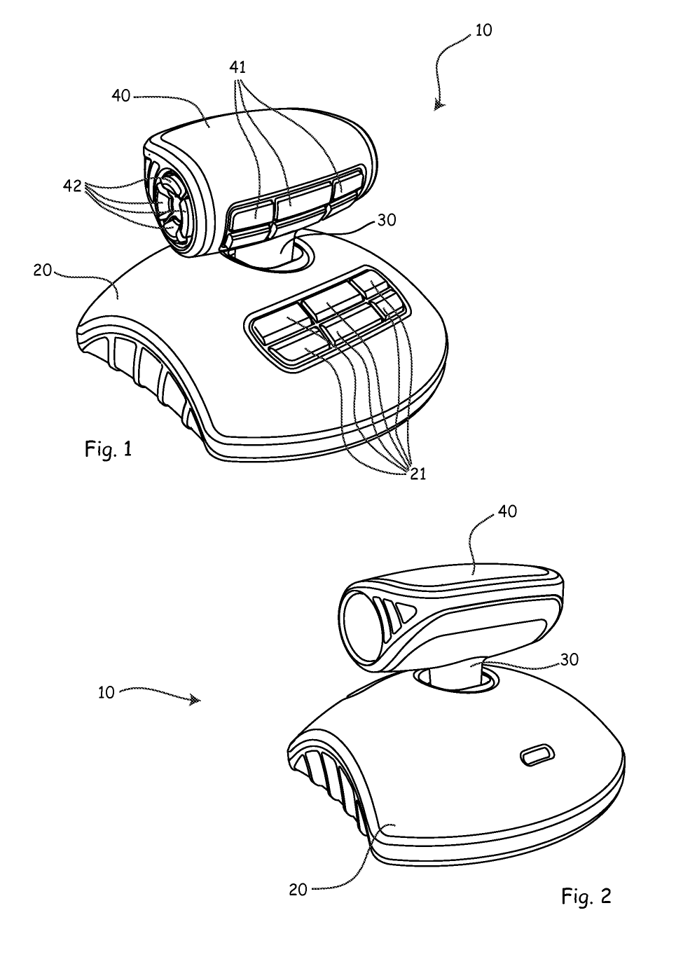

FIG. 1 is a front perspective view of a computer input device according to selected embodiments of the current disclosure. The computer input device 10 has a base 20, stick 30, and handle 40. The handle 40 includes pad buttons 42 on the right side of the handle, as well as a plurality of handle buttons 41 located on the front side of the handle 40. The base 20 of the computer input device 10 also includes buttons 21. The fingers of the user's hand that grasps the handle 40 of the computer input device 10 may press buttons 21 on the base 20. It should be appreciated that the pad buttons 42 may instead or additionally be located on the left side of the handle such that the opposite hand may be used to interact with the computer input device.

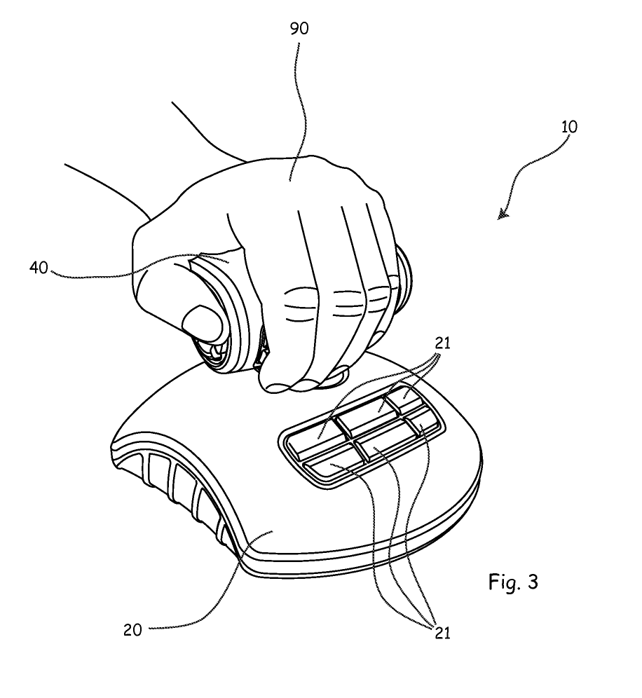

FIG. 2 is a back perspective view of a computer input device according to selected embodiments of the current disclosure. The computer input device 10 has a base 20, stick 30, and handle 40, where the stick 30 connects the handle 40 to the base 20. A user grasps the handle 40, which is horizontally oriented and perpendicular to the stick 30. By moving the handle 40 forwards, backwards, sideways to the left, or sideways to the right, a user causes the angle of the stick 30 to change relative to the base 20. This change in angle can be read in using sensors, such as potentiometers.

FIG. 3 is a front perspective view of a hand grasping a computer input device according to selected embodiments of the current disclosure. In this figure, a user's left hand 90 grasps the handle 40 of the computer input device 10. The user's thumb is able to press any one of the plurality of pad buttons (not clearly visible in this figure) on the right side of the handle 40. The fingers of the user's hand 90 may press the handle buttons 41 (not clearly visible in this figure), or may extend downward to press the buttons 21 on the base 20. Note that the same finger may have access to multiple buttons.

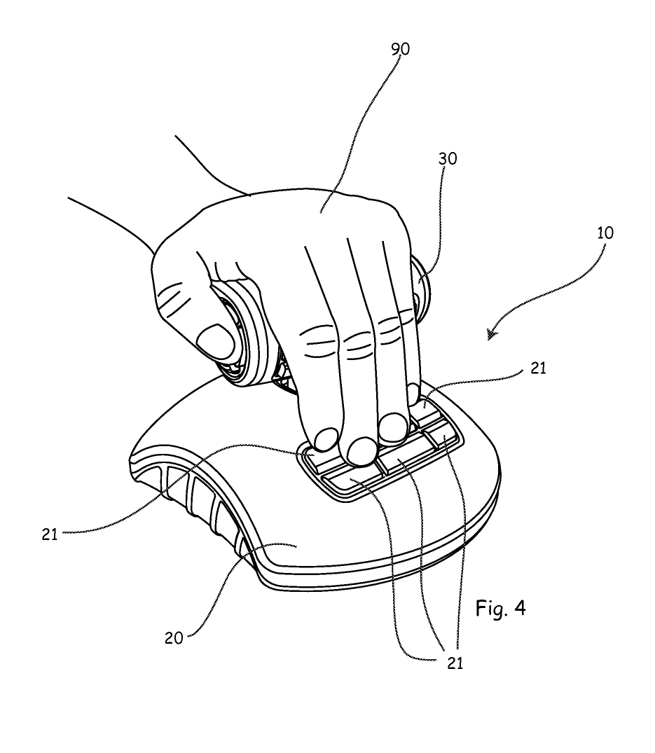

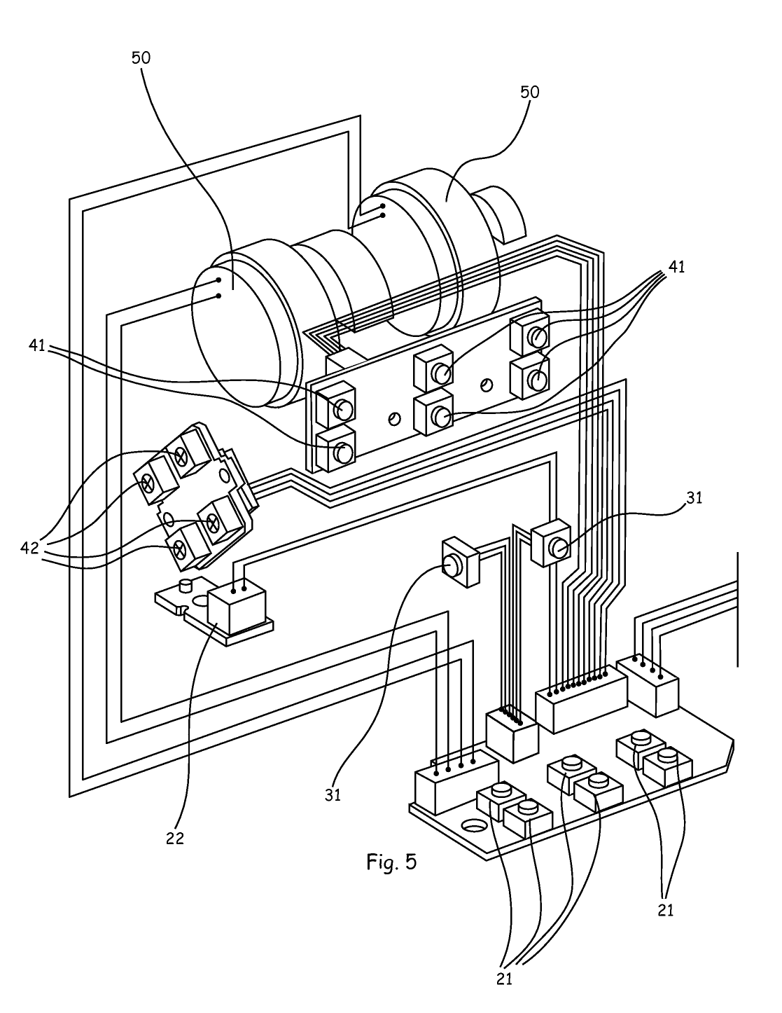

FIG. 4 is a front perspective view of a user engaging buttons on the base of a computer input device according to selected embodiments of the current disclosure. A user's hand 90 grasps the handle 40, where the fingers of hand 90 are extended to depress, or activate, buttons 21 located on the base 20 of the computer input device 10.

FIG. 5 is a schematic view of electrical components of a computer input device according to selected embodiments of the current disclosure. A user interacts with a 3D environment through moving the handle, which in turn moves the stick, of the computer input device. Movement of the stick, or more specifically the angular displacement of the stick, is measured by stick sensors 31. Stick sensors 31 may be potentiometers, which are capable of translating the angle of the stick into an electrical signal. Since there are two stick sensors, the angular displacement along two axes may be determined. The user may also press buttons 21, handle buttons 41, or pad buttons 42. These buttons are electrically connected to a main board 15. Motors 50 are used to provide haptic feedback to the user. Two motors in mechanical connection with the stick allow for force feedback applied on two axes. By appropriately varying the force applied by the motors, the computer input device can vibrate or rumble. A light emitting diode (LED) 22 is used to provide visual feedback to users. The LED 22 is located in the base of the computer input device. If the external surface of the base is opaque, then the LED 22 should extend therethrough.

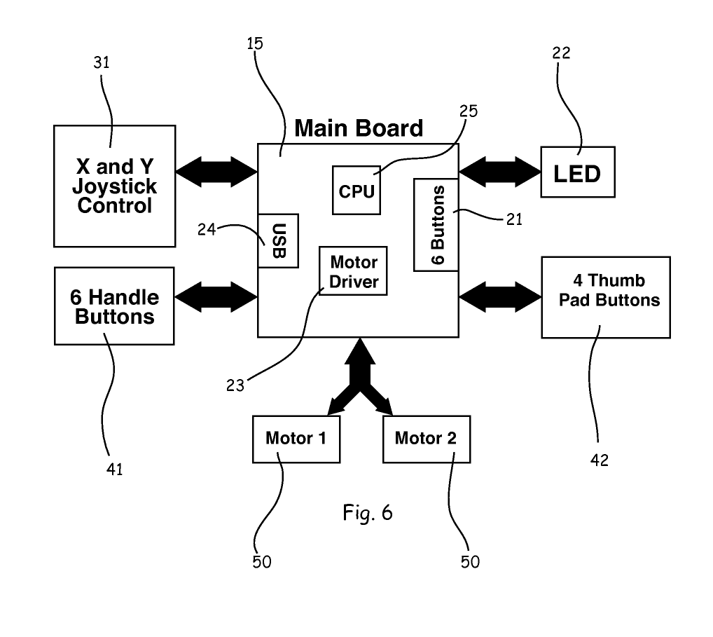

FIG. 6 is a diagram of the main electrical components of a computer input device according to selected embodiments of the current disclosure. The buttons 21 located on the main board 15 as well as LED 22, stick sensors 31, handle buttons 41, and pad buttons 42 located off of the main board 15 are in electrical connection with the main board 15. Motors 50 are in electrical connection with the motor driver 23, which is located on the main board 15. A central processing unit (CPU) 25 is also located on the main board 15, and controls and processes signals from the electrical components of the computer input device. A data port, such as a universal serial bus (USB) 24, provides a communication link with an external source, such as a personal computer.

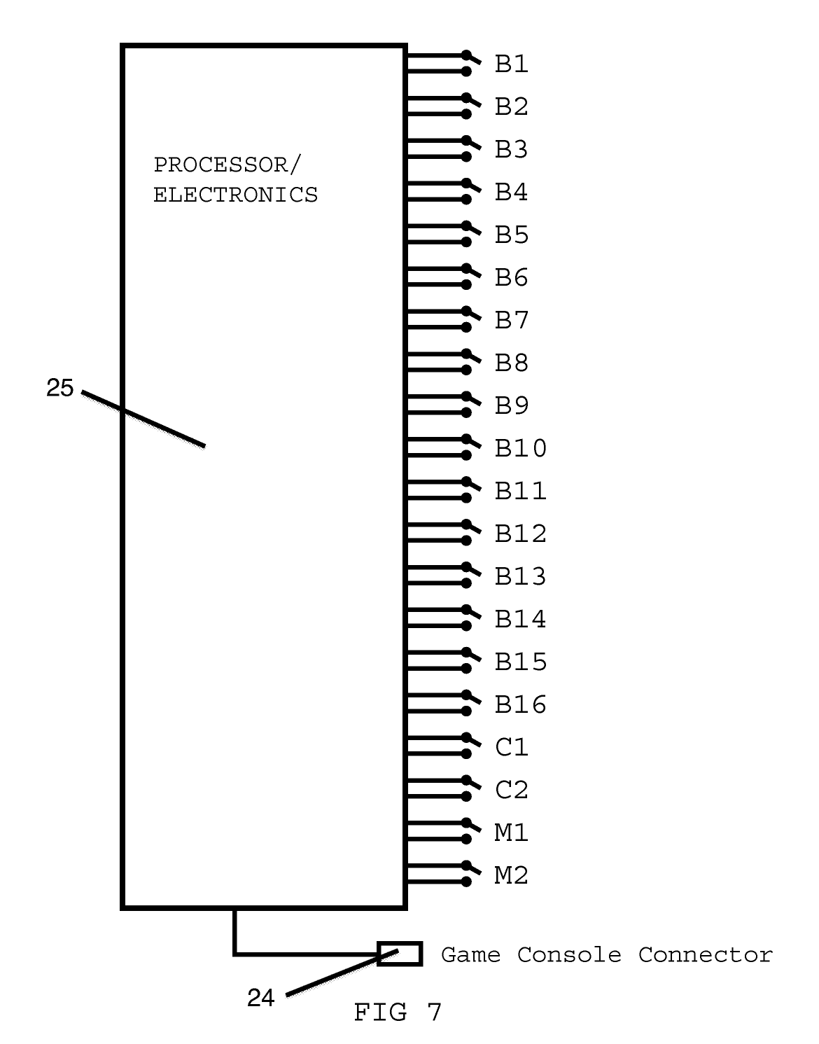

FIG. 7 is a diagram of the connections between a computer input device and a game console connector according to selected embodiments of the current disclosure. Input from the buttons is accepted through connections B1 through B16. Input from a mechanism to translate the relative angle (or displacement angle) of the stick into an electrical signal, such as a potentiometer, is accepted through connections C1 and C2. The inputs from these connections are processed by the central processing unit 25, which then provides output through a data port such as a universal serial bus 24, or other similar means of communication, to an external device such as a computer, a game console, or other electronic device. Motors are activated and controlled through connections M1 and M2. Input for controlling motors through M1 and M2 may be provided by a computer, game console, or other electronic device through universal serial bus 24.

As described above, the computer input device provides input for a computer or like device. The computer or like device may be a variety of electronic devices including without limitation, personal computers, mainframe computers, tablet computers, gaming consoles, and televisions. Furthermore, the above referenced devices may also provide input to the computer input device, such as for providing haptic or visual feedback to the user. In addition to the buttons described above, one or more scroll wheels and/or throttle controls may be integrated therein. The scroll wheels or throttle controls may be accessible by a thumb or finger of the user.

The handle in a horizontal orientation also has the benefit of providing a computer input device with a low profile. Typical joysticks used in the gaming environment with vertical handles can be seven inches tall or more. The current invention, however, can be less than four and one-half inches (4½″) tall. Thus, when the current invention is used in conjunction with a standard computer mouse, the difference in elevation between the user's hands is much less than if the user was using a standard joystick with a vertical handle. The low profile of the current invention also results in a low center of gravity, which in turn reduces the required footprint of the device. To prevent the computer input device from tipping over, the base of the computer input device must be of a width and depth to resist such an occurrence under normal operating conditions. With a lower center of gravity, the tendency for the computer input device to tip over is reduced, thus requiring a smaller base size and overall footprint of the device. Additionally, the user generally applies a downward force that also reduces the tendency for the computer input device to tip over.

The computer input device of the current invention can receive input through movements of the handle and stick. In one embodiment, the stick has two axes of movement, for example, movement forward and back and movement from side to side. A second embodiment adds a third axis, wherein the stick may be rotated about its longitudinal axis in addition to forward and backward and side-to-side movement. In yet another embodiment, rotation about the longitudinal axis of the handle is measured, where this additional axis is perpendicular to the longitudinal axis of the stick. The handle is allowed to rotate forward and backward on the stick, similar to the action of the throttle of a typical motorcycle.

In an alternative embodiment, the computer input device transmits its input signals to a computer by means of a wireless connection instead of a wired connection. For example, the computer input device may operably connect to a computer by means of a Bluetooth connection, wherein the data port would be the Bluetooth network communication interface.

Another embodiment provides a computer input device with internal lights that provide visual feedback to the user. With a transparent or translucent covering, internal lights will shine through to indicate different situations to a user. For example, the computer input device can flash red when the user's computer character is hit, change color depending on the user's computer character's health, change color to display the relative change in a stock market index (such as red for a loss and green for a gain), and/or flash when a message is received by the computer. In this fashion, the computer sends an input to the computer input device to cause such a color to display from the computer input device. The covering of the computer input device may be colored as well, wherein logos and/or advertisements may be affixed thereto.

Galvanic skin detection to detect perspiration from the user's hand may be integrated into the computer input device. Such a feature enables game manufacturers to more clearly understand and program for stressful areas of a game and to optimize game play accordingly. Along this similar line of thought, heat sensor and/or heart rate monitors may be integrated as well, also to measure the stress of the user at various points in time.

In yet a further embodiment, the computer input device can vibrate to provide tactile feedback to the user, through the use of one or more devices such as the motors described above. For example, the computer may send a signal to the computer input device to cause it to vibrate when the user's character is injured.

In another embodiment, a method is provided for aiding an individual in interacting with a computer, particularly three-dimensional environments rendered by a computer. First, an individual obtains a computer input device, where the computer input device has a base stick, and handle. The handle includes pad buttons on the right side of the handle, as well as a plurality of handle buttons located on the front side of the handle. The base of the computer input device also includes buttons. A user grasps the handle of the computer input device, and displaces or moves the stick around to provide directional input to the computer. The user may also depress one or more of the bottoms on either the handle or the base, either while the stick is displaced or some period of time before or after. In this manner, those with undeveloped dexterity (such as children), arthritis, carpal tunnel, tendinitis, or other joint ailments (such as the elderly), and others with reduced cognitive abilities (such as individuals with autism or other mental disabilities) may interact with a computer to achieve various tasks, including navigating two-dimensional and three-dimensional environments.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A computer input device comprising
a base, a stick, a handle, two stick sensors, two motors, a light emitting diode, a central processing unit, and a data port,
where the stick operably connects the handle to the base, where the handle is perpendicular to the stick,
where the handle comprises a plurality of handle buttons and a plurality of pad buttons, wherein a user may depress one or more of the handle buttons with the user's fingers, wherein a user may depress one or more of the pad buttons with the user's thumb,
where the base comprises a plurality of buttons, wherein a user may depress one or more of the buttons of the base with the user's fingers,
where the central processing unit processes input provided by the handle buttons, the pad buttons, the buttons of the base, and the stick sensors, where the central processing unit provides output through the data port, where the central processing unit activates the motors and light emitting diode,
where the two stick sensors measure angular displacement of the stick,
where the two motors are in mechanical connection with the stick such that the motors provide force feedback to a user when activated by the central processing unit,
whereby a user may interact with a computer connected to the computer input device via the data port by displacing the stick or depressing one or more of the pad buttons of the handle, the handle buttons of the handle, or the buttons of the base.

2. The computer input device of claim 1, wherein the data port is a universal serial bus.

3. The computer input device of claim 1, wherein the plurality of pad buttons of the handle comprises four pad buttons.

4. The computer input device of claim 1, wherein the plurality of handle buttons of the handle comprises six buttons.

5. The computer input device of claim 1, wherein the plurality of buttons of the base comprises six buttons.

6. A computer input device comprising
a base, a stick, and a handle,
where the stick operably connects the handle to the base, where the handle is perpendicular to the stick,
where the handle comprises a plurality of handle buttons and a plurality of pad buttons, wherein a user may depress one or more of the handle buttons with the user's fingers, wherein a user may depress one or more of the pad buttons with the user's thumb.

7. The computer input device of claim 6, wherein the base comprises a plurality of buttons, wherein a user may depress one or more of the buttons of the base with the user's fingers.

8. The computer input device of claim 6, further comprising two stick sensors, where the two stick sensors measure angular displacement of the stick.

9. The computer input device of claim 6, further comprising two motors, where the two motors are in mechanical connection with the stick such that the motors provide force feedback to a user.

10. The computer input device of claim 6, further comprising a central processing unit, where the central processing unit processes input provided by the handle buttons of the handle and the pad buttons of the handle.

11. The computer input device of claim 6, wherein the base further comprises a light emitting diode.

12. The computer input device of claim 6, further comprising a data port, where the data port provides a communication link to an external device.

13. The computer input device of claim 12, wherein the external device is a personal computer.

14. The computer input device of claim 12, wherein the data port is a universal serial bus.

15. The computer input device of claim 1, wherein the plurality of pad buttons of the handle comprise four pad buttons.

16. The computer input device of claim 1, wherein the plurality of handle buttons of the handle comprise six buttons.

17. The computer input device of claim 1, wherein the plurality of buttons of the base comprise six buttons.

18. A method of controlling a computer comprising the steps of:
obtaining a computer input device comprising a base, a stick, a handle, and a data port, where the stick operably connects the handle to the base, where the handle is perpendicular to the stick, where the handle comprises a plurality of handle buttons and a plurality of pad buttons, wherein a user may depress one or more of the handle buttons with the user's fingers, wherein a user may depress one or more of the pad buttons with the user's thumb,
connecting a personal computer to the computer input device via the data port, and
providing directional input to the computer by displacing the stick.

19. The method of claim 18, further comprising the step of providing input to the computer by depressing one or more of the plurality of handle buttons or plurality of pad buttons.

20. The method of claim 18, wherein the computer input device is manipulated by an individual selected from the group consisting of individuals with undeveloped dexterity, individuals with arthritis, individuals with carpal tunnel, individuals with tendinitis and individuals with reduced cognitive abilities.
